(19) United States
(12) Patent Application Publication
(10) Pub. No.: US 2009/0308872 A1
(43) Pub. Date: Dec. 17, 2009

(54) Fluid Port for Laminated Devices

(75) Inventor: Scott Stephen Breidenthal, Vista, CA (US)

Correspondence Address: FISH & ASSOCIATES, PC;ROBERT D. FISH, 2603 Main Street, Suite 1000, Irvine, CA, 92614-6232, US

(73) Assignee: QUALIGEN, INC., Carlsbad, CA (US)

(21) Appl. No.: 12/297,063

(22) PCT Filed: Apr. 12, 2007
(86) PCT No.: PCT/US2007/009118

§ 371 Date: Feb. 19, 2009

Related U.S. Application Data
(60) Provisional application No. 60/744,889, filed on Apr. 14, 2006.

(51) Int. Cl. B65D 37/00; B65D 30/22; B65D 33/04; B67D 5/38; B23P 11/00; B65D 33/36

(52) U.S. Cl. 220/502; 220/526; 222/94; 222/159; 29/428

(57) ABSTRACT

A container is formed from flexible top and bottom sheets and further includes an energy-deformable conduit. Contemplated containers include a plurality of compartments and a sample receiving compartment, wherein the conduit allows feeding a fluid into the sample compartment without feeding the fluid in the remaining compartments, which is preferably achieved by a flow-restriction portion in the conduit and a flow-control element between the sample receiving compartment and one or more of the compartments.

This application claims priority to our copending U.S. provisional patent application with the Ser. No. 60/744,889, filed Apr. 14, 2006, and which is incorporated by reference herein.

### FIELD OF THE INVENTION

The field of the invention is fluid manipulation, especially as it relates to fluid delivery into flexible fluid containers.

### BACKGROUND OF THE INVENTION

Flexible fluid containers, and especially those for medical test systems have a variety of advantages, including their resilience to external forces, which makes them especially suitable for emergency use as well as their capability to be rolled, stacked, or otherwise tightly packed in a not necessarily cube- or block-shaped package.

However, while such advantages are clearly desirable, various disadvantages are often associated with flexible fluid containers. Most typically, filling operation of such containers either requires the container walls to be maintained in a fixed position to avoid reverse fluid flow, or a commercially available check valve that generally adds substantial expense to the fluid container. Moreover, all or almost all of the known commercially available check valves have a relatively large diameter, which interferes with tight packing or rolling of such containers. Alternatively, specific filling devices may be provided for flexible containers that often solve problems associated with backflow. However, such filling devices tend to be relatively expensive, require maintenance and often trained personnel. Moreover, such filling devices typically require special fixturing and/or tooling for fluid introduction and retention in one or more fluid chambers of the flexible containers.

Most inconveniently, the unpredictable internal volume of the pouch chambers (e.g., due to inclusion/introduction of air during manufacture, handling and storage) remains a critical factor that often contributes to inaccuracies. Currently, this variation in pre-filled internal volume is equalized by applying vacuum to the external walls on both sides of the chamber with suction cups or a vacuum manifold to create a uniform opening of the internal volume. Alternatively, a mechanical device can be inserted into the throat of the pouch chamber to mechanically “pre-open” throat and chamber to allow sufficient space to allow fluid filling. An alternative to opening the pouch chamber is to add an air/fluid tight filling port to the throat of the chamber to provide the introduction of fluids at above ambient pressure. An example of this method would be to attach a septum to the throat of a chamber allowing the introduction of fluids using a syringe. While such septa provide an attractive route to filling a pouch, filling requires an operator to inject the fluid with a needle, which will raise the risk of injury and slow down the filling process. To overcome the disadvantages associated with needle operation is to replace the needle port with a disposable luer (lock) adapter. However, once the fluid has been introduced into the pouch through such a luer adapter, any disturbance of the pouch or pressure on the chamber will cause fluid to be expelled from the chamber.

Alternatively, a check valve may be used on a pouch through which fluid is pumped with a disposable syringe. Exemplary check valves are depicted in Prior Art FIG. 1. While such check valves not only provide a convenient and needle-less access to a sample pouch but also prevent reverse flow of fluid from the pouch, they add significant expense to the pouch construction. Still further, due to the relatively large size of such check valves, many of the advantages of a reagent pouch are lost. Still another alternative type of check valve is sometimes referred to as a “duck bill”. Several varieties of this technology exist and one in particular is depicted in http://www.dielectrics.com/pages/10041.html. The drawback of this technology is that it does not provide a positive seal during fluid introduction to prevent backflow or leakage.

Therefore, while numerous devices and methods for filling medical devices with various fluids are known in the art, all or almost all of them suffer from one or more disadvantages, and especially where the medical device is a flexible pouch. Consequently, there is still a need to provide improved composition and methods to improve wear resistance in such products.

### SUMMARY OF THE INVENTION

The present invention is directed to devices and methods for containers, and especially for containers for diagnostic test in which the container is formed from flexible top and bottom sheets, and in which the container further includes an energy-deformable low-profile conduit that allows uni-directional delivery of a fluid to a sample receiving compartment. In further preferred aspects, the container further includes a plurality of additional compartments wherein at least one of those is fluidly coupled to the sample receiving compartment. The container is still further preferably configured such that delivery of the fluid to a sample receiving compartment is selective and not necessarily to the remaining compartments. Most preferably, the energy-deformable low-profile conduit has a luer lock to allow for fast and safe delivery of the fluid to the sample receiving compartment. It should be noted that laminated devices according to the inventive subject matter can be prepared such that the devices can be rolled or otherwise deformed in a compact configuration.

In one aspect of the inventive subject matter, a container comprises a flexible top sheet and a flexible bottom sheet coupled together and configured as a flat pouch, wherein the flexible top and bottom sheets are further coupled together to form a sample receiving compartment and a plurality of additional compartments, and wherein the flexible top and bottom sheets are further configured such that at least some of the additional compartments are fluidly coupled to each other and wherein the sample receiving compartment is fluidly coupled to at least one of the additional compartments via a flow-control element. The energy-deformable conduit in contemplated devices has an outer surface, a distal end, a proximal end, and a flow-restriction portion, wherein the outer surface of the conduit is disposed between and sealingly coupled to the top sheet and the bottom sheet, and wherein the distal end extends into the sample receiving compartment, wherein the proximal end includes an adapter, and wherein the flow-restriction portion is configured to allow uni-directional flow of a fluid through the conduit. In preferred devices, the container is configured to allow feeding of the fluid into the sample receiving compartment without feeding the fluid into the at least one of the additional compartments.

Most preferably, the flow-control element is a chevron seal or a passage that is compression-sealable by an actuator, and/or the top sheet and the bottom sheet are coupled together glue, a heat weld, and/or an ultrasound weld. Most typically, the energy-deformable conduit is part of a dispense tip. Therefore, in preferred aspects, the adapter comprises a luer lock, and the flow-restriction portion comprises a duckbill valve. In most of contemplated containers, at least one of the plurality of additional compartments includes a reagent, a buffer, a chromogenic or fluorogenic compound, and/or a solid. Where desired, contemplated devices can be coupled together in an end-to-end fashion, and be optionally rolled ort otherwise compacted for storage and use.

In another aspect of the inventive subject matter, a method of forming a container includes a step of providing a flexible top sheet, a flexible bottom sheet, and an energy-deformable conduit, wherein the energy-deformable conduit has an outer surface, a distal end, a proximal end, and a flow-restriction portion. In a further step, the energy-deformable conduit, the top sheet, and the bottom sheet are coupled together such that the outer surface of the conduit is disposed between and sealingly coupled to the top sheet and the bottom sheet, wherein the flexible top and bottom sheets are coupled such that a plurality of additional compartments and a sample receiving compartment are formed, and wherein the sample receiving compartment is fluidly coupled to at least one of the additional compartments via a flow-control element. In such methods, the distal end extends into the sample receiving compartment, wherein the proximal end includes an adapter, and wherein the flow-restriction portion is configured to allow unidirectional flow of a fluid through the conduit. Moreover, the container is preferably configured to allow feeding of the fluid into the sample receiving compartment without feeding the fluid into the at least one of the additional compartments.

Among other suitable choices, it is generally preferred that the step of coupling uses ultrasound welding, heat welding, and/or gluing, and that the flow-control element is a chevron seal or a passage that is compression-sealable by an actuator. In still further preferred methods, the energy-deformable conduit is part of a dispense tip, the adapter comprises a luer lock, and/or the flow-restriction portion comprises a duckbill valve. While not limiting to the inventive subject matter, it is typically preferred that at least a portion of the top sheet is transparent. Additionally, it is contemplated that suitable methods further include a step of filling into at least one of the plurality of additional compartments a reagent, a buffer, a chromogenic or fluorogenic compound, and/or a solid. Furthermore, where a second container is formed that is coupled to the first container, it is generally preferred that the containers are coupled to each other, preferably to allow winding of the containers about an axis to thereby form a roll.

Various objects, features, aspects, and advantages of the present invention will become more apparent from the following detailed description of preferred embodiments of the invention, along with the accompanying drawing.

### BRIEF DESCRIPTION OF THE DRAWINGS

Prior Art FIG. 1 depicts exemplary commercially available check valves.

FIG. 2A is a schematic illustration of a flexible container according to the inventive subject matter.

FIG. 2B is a schematic illustration of a plurality of containers of FIG. 2A that are coupled together in an end-to-end fashion and that are wound up into a roll.

FIG. 3A is a photograph of a dispense tip for use in contemplated devices and methods.

FIG. 3B is a photograph of energy-deformed dispense tips with uni-directional fluid flow for use in contemplated devices and methods.

FIG. 4 is a photograph of dispense tips integrated into a heat-welded seal of a flexible container according to the inventive subject matter.

### DETAILED DESCRIPTION

The inventors discovered that flexible fluid containers can be manufactured and/or filled in a simple and effective manner in which a check valve is formed in situ as the pouch is being formed from a generally flexible front and back sheet. Most preferably, the check valve is formed from a cylindrical or frustoconical conduit that has on one end a press-fit or luer (lock) connectivity, wherein the check valve is most preferably formed by application of heat and pressure.

The term “flexible” as used herein means readily deformable using moderate manual force (e.g., manual force similar to that used in a handshake). For example, a plastic film having a thickness of less than 1 mm (and more typically less than 0.1 mm) can be readily deformed to a roll or otherwise curved configuration by application of moderate manual force. In contrast, a metal plate having a thickness of 1 mm or more is not considered flexible as moderate manual force will not result in the same deformation. Furthermore, it should be noted that a flexible object need not necessarily regain its original configuration after the force is removed.

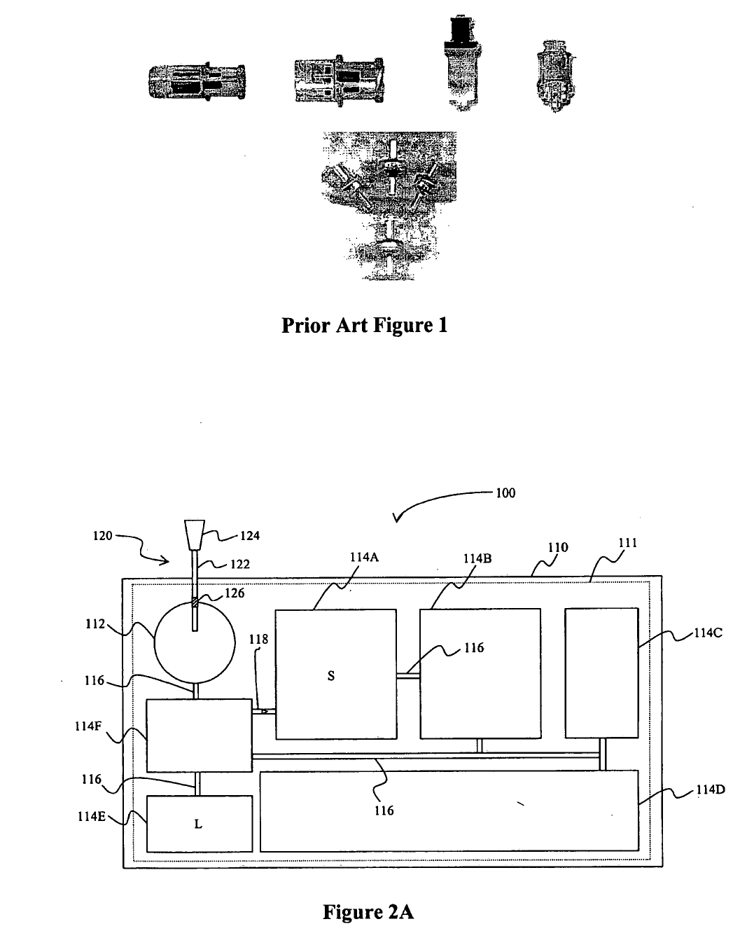

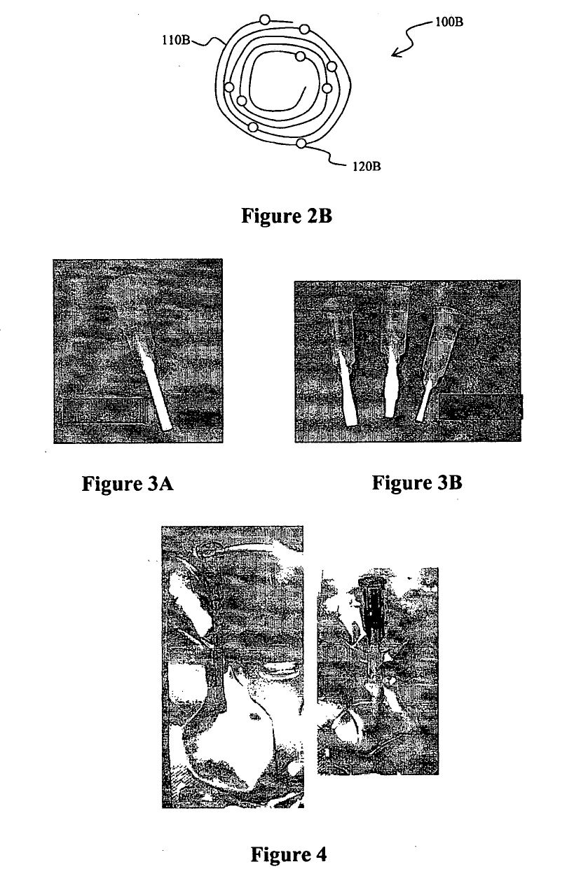

FIG. 2A exemplarily depicts a flexible container 100 that is formed from a flexible top sheet 110 and a flexible bottom sheet (not shown), which are coupled together via outer heat-weld 111. Formed by heat-welding seals between the top and bottom sheets are sample receiving compartment 112 and additional compartments 114A-114F, which are fluidly coupled to each other via fluid conduits 116 (also preferably formed by heat-welding). At least one, and more preferably some of the fluid conduits 116 include a chevron seal 118 which is configured to block fluid flow at a fluid pressure below design pressure. Above design pressure, the chevron seal breaks and then allows flow of the fluid.

Integrated into the flexible container is an energy-deformable conduit 120 via heat fusion between the outer surface of the conduit and the top and bottom sheet. Most typically, the heat fusion produces a fluid-tight barrier that prevents leakage of fluid along the outer surface from the inside of the container to the outside. The conduit 120 preferably includes a pipe portion 122, a distal end that extends into the sample receiving compartment 112, and a proximal end that most preferably comprises a luer lock adapter 124. In most typical embodiments, the flow-restriction portion 126 is formed as a duckbill valve in situ as the sample receiving compartment is being formed. At least some of the compartments may include a solid and/or liquid (S in compartment 114A and L in compartment 114E). FIG. 2B exemplarily depicts a plurality of containers 110B that are coupled together in an end-to-end fashion and that are rolled up into a wound configuration 100B. Here, the conduits 120B protrude from the side of the roll.

Thus, preferred flexible containers will a flexible top sheet and a flexible bottom sheet that are coupled together and configured as a flat pouch to form a sample receiving compartment and a plurality of additional compartments. Most typically, the at least some of the compartments are fluidly coupled to each other and the sample receiving compartment is fluidly coupled to at least one of the compartments via a flow-control element. It is further typically preferred that the energy-deformable conduit has an outer surface, a distal end, a proximal end, and a flow-restriction portion, wherein the outer surface of the conduit is disposed between and sealingly coupled to the top sheet and the bottom sheet, wherein the distal end extends into the sample receiving compartment, wherein the proximal end includes an adapter, and wherein the flow-restriction portion is configured to allow unidirectional flow of a fluid through the conduit (i.e., from the outside of the container through the conduit into the sample receiving compartment of the container). In especially preferred aspects, the container is configured to allow feeding of the fluid into the sample receiving compartment without feeding the fluid into the at least one of the additional compartments, which is typically achieved by various flow-control elements. For example, suitable flow control elements include chevron seals, compression-sealable conduits of geometry to allow blocking of fluid flow by an actuator that contacts the conduit, duckbill valves, spring-loaded valves, etc.

The top sheet and the bottom sheet are preferably coupled together by glue, and even more preferably by application of energy, including heat, compression, an RF, and/or ultrasound energy to thus produce a heat-weld, a compression weld, and/or an RF/ultrasound weld. Such coupling process is most preferably also employed to couple the energy-deformable conduit to the top and/or bottom sheet. It should be further noted that contemplated coupling processes can also be used to form the compartments and even the conduits in the final product. Thus, in most cases the entire container with compartments and fill port to the sample receiving compartment can be formed in a single step using a single tool. In further preferred aspects, at least a portion of the top is sheet is transparent, and the sheets are fabricated from a polymer foil having a thickness of between about 0.05 mm to about 3 mm.

In especially preferred aspects, the energy-deformable conduit is part of a commercially available dispense tip, which are commonly traded in numerous sizes and materials. However, particularly preferred dispense tips will be manufactured from a polymer (typically polyethylene or polypropylene, optionally fluorinated) and include a luer lock adapter portion. It has been recognized by the inventors that such tips include a pipe portion that is permanently deformable by application of various forms of energy (e.g., mechanical pressure, heat, ultrasound, etc.) and that the amount of energy required for formation of a duckbill valve is substantially the same (i.e., +/−15%) as the amount of energy required to couple to the top and bottom sheets together. Remarkably, not only dispense tips could be used in this manner, but also disposable pipette tips for microliter volume pipettes (e.g., Gilson tip −200 ul).

Consequently, it is especially preferred that the flow-restriction portion comprises a duckbill valve, which is most preferably formed in situ together with the step of coupling the top and bottom sheets. Alternatively, however, the flow-restriction portion may also be preformed, and the conduit may be integrated at a later step. In further preferred aspects, the step of coupling the top and bottom sheets is performed under conditions such that the outside surface of the conduit is sealingly coupled to at least one of the top and bottom sheets. Thus, it should be appreciated that the flow control portion may be within the seal of the pouch and/or compartment, but may also be at least partially in the pouch or compartment.

Where the conduit material has a melting point that is similar to the melting point of the container material, the conduit is preferably at least 2-times, more preferably 5-times thicker than the container material, and/or the inside of the conduit includes a material that will prevent sealing shut of the conduit. Alternatively, the conduit material has a melting point that is higher than the melting point of the pouch (container) material. Regardless of the melting points and/or added material to prevent sealing of the conduit, it is generally preferred that the conduit is sufficiently deformed in the pouch formation process to take on the shape of a duckbill valve. An exemplary picture of a suitable conduit with luer lock adapter is depicted in FIG. 3A, and FIG. 3B depicts the same and other similar conduits after heat/pressure deformation. It should be noted that the flattened portion in such conduits may on the end of the conduit and/or at a position intermediate to the end and the luer adapter. Most advantageously, such devices may be formed from inexpensive and commercially available needle-free dispense tips. FIG. 4 depicts an exemplary fluid port in which the conduit of a dispense tip is sealed into the sample receiving cavity of a pouch that has a flexible front and back sheet. The check valve is formed in such devices in the process of forming the compartments in the pouch, typically by heating and compression, which is sufficient to sealingly connect the flexible sheets and to non-sealingly deform the conduit of the dispense tip to form a check valve.

It should be especially appreciated that using such fabrication, no additional steps are required in which, for example, the conduit has to be fitted and sealed in a preformed opening, or in which a valve formation step is required after assembly of the pouch and insertion of the conduit. Viewed from a different perspective, it should be noted that the valve formation and insertion is performed at the same time as the container and its various compartments is formed. Alternatively, the dispense tip may be replaced by a pipette tip, which is also readily deformable to a check using the same heat and pressure that is needed for forming of a multi-compartment pouch. Remarkably, pouches and check valves formed according to the inventive subject matter exhibit superior one-way flow control at minimal capital expense. Moreover, such valves are reliably formed in the process of forming the pouch without the need of exact insertion of a conduit as the pouch sealingly engages with the conduit in the process of manufacture. It should therefore be recognized that regardless of the particular shape and configuration of the conduits, application of energy, and especially heat and pressure, will be effective to flatten a section of the conduit, which creates a restriction of flow that allows fluid to be dispensed from a dispenser through the conduit into a pouch compartment and that prevents air or fluid to be drawn back into the dispenser (e.g., syringe, pump, etc.). As noted above, the heat and pressure can be applied before the conduit is inserted into the sample port, but it is generally preferred that the pouch is formed concurrently with the formation of the flattened section, which will also sealingly integrate the conduit into the so formed pouch. Once sealed into the sample port of the pouch, the modified dispense or pipette tip will act as a disposable needleless injection site with integrated check-valve capability.

In some embodiments, the materials chosen for the pouch construction and those used for the conduit may not produce a fluid-tight bond between the exterior of the conduit and the interior walls of the pouch. In these instances a secondary application of any variety of adhesives may be necessary at the interface between the conduit and pouch to enhance this bond and provide a fluid-tight seal. This secondary adhesive operation may be utilized whether the deformation heat and pressure are applied to the conduit prior to insertion into the pouch or concurrently with the forming of the pouch. Regardless of the manner of forming the container, it is generally preferred that at least one of the plurality of additional compartments comprises a solid or fluid, such as a reagent, a buffer, a chromogenic or fluorogenic compound, a magnetic bead, etc.

Therefore, it should be recognized that presently contemplated devices will have several advantages over currently known devices. Among other things, the so formed fluid port is substantially smaller in diameter, does not deform the sample chamber as the conduit is typically equally thin or even thinner than the height of the sample receiving compartment, and the conduit can be sealed directly into the throat of the sample port. Moreover, as the deformed conduit has check valve capability, the container can be filled at significant overpressure without backflow when the filling device is withdrawn. Still further, and where desired, the conduit may include an integrated luer fit and/or lock. Finally, as the conduit is fabricated in a single piece, no assembly is required and function is highly reliable.

In still further contemplated alternative aspects, it should be appreciated that a pouch may have multiple fluid ports, wherein at least one of them may include additional functionalities (e.g., branched conduit, self-sealing injection port, etc.). Moreover, while it is generally preferred that heat is used to seal the device into the pouch, gluing, ultrasonic welding, or other manners are also deemed suitable for use herein. Moreover, various gauge needle canulae or cone orifices may be employed to control filling of the pouch compartments. Where desirable, the conduit may employ a luer, luer lock, or other suitable fluid-tight fitments for interface with the fluid dispenser. It should further be noted that the flattened portion in the conduit may be formed at various locations (from the distal tip to mid or proximal locations) depending on the desired final configuration or assembly attributes. Finally, while contemplated devices will most preferably include pouch-type configurations in which the front and back of the pouch are laminated together to form an entirely flexible pouch, it is contemplated that the inventive subject matter may also be used in conjunction with other configurations in which a heat/pressure step forms a compartment of a device, and especially laminated devices. For example, one or more of the walls of suitable devices may be rigid, or a pair of relatively inflexible plates with deformable blisters may be used to form an analytical device. Another example would be the placement of the conduit between two internal chambers of the pouch to provide a check valve function in lieu of a frangible seal. One of the advantages of this type of internal seal over the frangible seal is the reduction of mechanical/pneumatic actuators required to prevent backflow once a frangible seal has been ruptured.

Therefore, and viewed from a different perspective, a method of forming a container may include a step of providing a flexible top and bottom sheet, and an energy-deformable conduit, wherein the energy-deformable conduit has an outer surface, a distal end, a proximal end, and a flow-restriction portion. Contemplated methods will further include a step of coupling the energy-deformable conduit, the top sheet, and the bottom sheet together such that the outer surface of the conduit is disposed between and sealingly coupled to the top sheet and the bottom sheet, wherein the flexible top and bottom sheets are coupled such that a plurality of additional compartments and a sample receiving compartment are formed, and wherein the sample receiving compartment is fluidly coupled to at least one of the additional compartments via a flow-control element. Most typically, the distal end extends into the sample receiving compartment, wherein the proximal end includes an adapter, and wherein the flow-restriction portion is configured to allow uni-directional flow of a fluid through the conduit, and it is further generally preferred that the container is configured to allow feeding of the fluid into the sample receiving compartment without feeding the fluid into the at least one of the additional compartments. Further configurations, contemplations, and uses are described in U.S. Pat. Nos. 6,426,230 and 6,300,138, both of which are incorporated by reference herein.

Thus, specific embodiments and applications for improved fluid ports for laminated devices have been disclosed. It should be apparent, however, to those skilled in the art that many more modifications besides those already described are possible without departing from the inventive concepts herein. The inventive subject matter, therefore, is not to be restricted except in the spirit of the present disclosure. Moreover, in interpreting the specification and contemplated claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A container comprising:
a flexible top sheet and a flexible bottom sheet coupled together and configured as a flat pouch;
wherein the flexible top and bottom sheets are further coupled together to form a sample receiving compartment and a plurality of additional compartments;
wherein the flexible top and bottom sheets are further configured such that at least some of the additional compartments are fluidly coupled to each other and wherein the sample receiving compartment is fluidly coupled to at least one of the additional compartments via a flow-control element;
an energy-deformable conduit having an outer surface, a distal end, a proximal end, and a flow-restriction portion, wherein the outer surface of the conduit is disposed between and sealingly coupled to the top sheet and the bottom sheet;
wherein the distal end extends into the sample receiving compartment, wherein the proximal end includes an adapter, and wherein the flow-restriction portion is configured to allow uni-directional flow of a fluid through the conduit; and
wherein the container is configured to allow feeding of the fluid into the sample receiving compartment without feeding the fluid into the at least one of the additional compartments.

2. The container of claim 1 wherein the flow-control element is a chevron seal or a passage that is compression-sealable by an actuator.

3. The container of claim 1 wherein the top sheet and the bottom sheet are coupled together by at least one of glue, a heat weld, and an ultrasound weld.

4. The container of claim 3 wherein the outer surface and at least one of the top sheet and the bottom sheet are coupled together by at least one of glue, a heat weld, and an ultrasound weld.

5. The container of claim 1 wherein the energy-deformable conduit is part of a dispense tip.

6. The container of claim 1 wherein the adapter comprises a luer lock.

7. The container of claim 1 wherein the flow-restriction portion comprises a duckbill valve

8. The container of claim 1 wherein at least a portion of the top sheet is transparent.

9. The container of claim 1 wherein at least one of the plurality of additional compartments comprises a substance selected from the group consisting of a reagent, a buffer, a chromogenic or fluorogenic compound, and a solid.

10. A plurality of containers according to claim 1 coupled together in an end-to-end fashion.

11. A method of forming a container, comprising:
providing a flexible top sheet, a flexible bottom sheet, and an energy-deformable conduit, wherein the energy-deformable conduit has an outer surface, a distal end, a proximal end, and a flow-restriction portion;
coupling the energy-deformable conduit, the top sheet, and the bottom sheet together such that the outer surface of the conduit is disposed between and sealingly coupled to the top sheet and the bottom sheet;
wherein the flexible top and bottom sheets are coupled such that a plurality of additional compartments and a sample receiving compartment are formed, and wherein the sample receiving compartment is fluidly coupled to at least one of the additional compartments via a flow-control element;
wherein the distal end extends into the sample receiving compartment, wherein the proximal end includes an adapter, and wherein the flow-restriction portion is configured to allow uni-directional flow of a fluid through the conduit; and
wherein the container is configured to allow feeding of the fluid into the sample receiving compartment without feeding the fluid into the at least one of the additional compartments.

12. The method of claim 11 wherein the step of coupling uses a process selected from the group consisting of ultrasound welding, heat welding, and gluing.

13. The method of claim 11 wherein the flow-control element is a chevron seal or a passage that is compression-sealable by an actuator.

14. The method of claim 11 wherein the energy-deformable conduit is part of a dispense tip.

15. The method of claim 11 wherein the adapter comprises a luer lock.

16. The method of claim 11 wherein the flow-restriction portion comprises a duckbill valve.

17. The method of claim 11 wherein at least a portion of the top sheet is transparent.

18. The method of claim 11 further comprising a step of filling into at least one of the plurality of additional compartments a substance selected from the group consisting of a reagent, a buffer, a chromogenic or fluorogenic compound, and a solid.

19. The method of claim 11 further comprising a step of forming a second container using the steps of claim 11, wherein the second container is coupled to the container.

20. The method of claim 19 further comprising a step of winding the container and the second about an axis to thereby form a roll.
